(19) United States
(12) Patent Application Publication
(10) Pub. No.: US 2005/0117727 A1
(43) Pub. Date: Jun. 2, 2005

(54) Telephone exchange apparatus, telephone exchange system, method of controlling telephone exchange apparatus, and control method for use in telephone exchange system

(75) Inventor: Seiji Tahi, Fussa-shi (JP)

Correspondence Address: Finnegan, Henderson, Farabow , Garrett & Dunner,;L.L.P., 1300 I Street, N.W., Washington, DC, 20005-3315, US

(73) Assignee: KABUSHIKI KAISHA TOSHIBA

(21) Appl. No.: 10/969,183

(22) Filed: Oct. 21, 2004

(30) Foreign Application Priority Data
Nov. 28, 2003 (JP) 2003-400890

(51) Int. Cl. H04M 1/00; H04M 3/42

(52) U.S. Cl. 379/156

(57) ABSTRACT

A telephone exchange apparatus includes a first storage unit to store a plurality of call process information for executing mutually different call process functions to the telephone terminal, in a first memory, a second storage unit to store permit information for executing a specified call process function out of the plurality of call process functions, the permit information being preliminarily stored in each device, in an information write disable second memory, a reader which reads out corresponding call process information from the first memory according to the requested call process function, reads out permit information from the second memory, and controller which controls about the execution of the call process function on based on these information.

### CROSS-REFERENCE TO RELATED APPLICATIONS

This application is based upon and claims the benefit of priority from prior Japanese Patent Application No. 2003-400890, filed Nov. 28, 2003, the entire contents of which are incorporated herein by reference.

### BACKGROUND OF THE INVENTION

1. Field of the Invention

The present invention relates to telephone exchange apparatus, a telephone exchange system, and a method of controlling the telephone exchange apparatus and telephone exchange system intended to prevent illegal use of a telephone exchange apparatus such as a key telephone apparatus or a private branch exchange (PBX).

2. Description of the Related Art

Hitherto, in office and other buildings, the telephone exchange apparatuses such as a key telephone apparatus and PBX have been widely used. This kind of telephone exchange apparatus contains telephone sets as extension terminals, and enables calls by switching and connecting between the extension terminals and the external network such as a public telephone network, and between mutual extension terminals.

In such a system, call process type information is preliminarily stored in the telephone exchange apparatus, and switching operation is executed on the basis of this call process type information. After start of use, however, it may be necessary to add a new function or delete an undesired function. In such a case, in the prior art, for example, the user requests the maker to add a function, and the maintenance service engineer of the maker sets to add the function desired by the user in the telephone exchange apparatus.

Since such setting operation is a simple job of only rewriting the call process type information registered in the telephone exchange apparatus, it can be set easily by an unlicensed user, which may be a loss for the maker. Or the call process type information may be altered by an illegal third party or illegal use by a third party may occur.

To prevent such an inconvenience in the system, it has been proposed to store an ID in the telephone exchange apparatus, and receive the ID or ciphered ID from a remote system to compare with the ID stored in the telephone exchange apparatus, and control the call process action is not coinciding (for example, see Jpn. Pat. Appln. KOKAI Publication No. 7-170545 and Jpn. Pat. Appln. KOKAI Publication No. 2000-66775).

In this method, however, since the ID or the like must be received from the remote system, it may take much time and labor from request of use of function until start of call process action. As a result, the user cannot use the requested function on the spot. In addition, the security of the remote system is not sufficient, and stealing of the ID by an illegal third party may occur.

### BRIEF SUMMARY OF THE INVENTION

It is hence an object of the invention to provide a telephone exchange apparatus, a telephone exchange system, and a method of controlling the telephone exchange apparatus and telephone exchange system intended to prevent illegal use of a telephone exchange apparatus and telephone terminal, and allowing the user to use a required function instantly.

According to an aspect of the present invention, there is provided a telephone exchange apparatus adapted to connect at least one telephone terminal via a communication network, the apparatus comprising: a first storage unit to store a plurality of call process information for executing mutually different call process functions to the telephone terminal, in a first memory; a second storage unit to store permit information for executing a specified call process function out of the plurality of call process functions, the permit information being preliminarily stored in each device, in an information write disable second memory; and a reader which reads out corresponding call process information from the first memory according to the requested call process function, reads out permit information from the second memory, and a controller which controls about the execution of the call process function on based on these information.

According to another aspect of the present invention, there is provided a telephone exchange system comprising a telephone exchange apparatus to exchange a plurality of communication lines, and a telephone terminal connected to a terminal end of each of the communication lines, wherein the telephone terminal comprises: a first storage unit to store first type information showing a type of an own terminal in an information write disable first memory, the telephone exchange apparatus comprises: a second storage unit to store second type information showing a type of a telephone terminal to be connected in an information write disable second memory; a reader which acquires the first type information from the telephone terminal, reads out the second type information from the second memory, when the telephone terminal is connected to the communication line; and a controller which controls about connection validation of the telephone terminal by comparing the first type information and the second type information.

According to yet another aspect of the present invention, there is provided a method of controlling a telephone exchange apparatus adapted to connect at least one telephone terminal via a communication line, the method comprising: storing a plurality of call process information for executing mutually different call process functions to the telephone terminal in a first memory; storing permit information for executing a specified call process function out of the plurality of call process functions, the permit information being preliminarily stored in each device, in an information write disable second recording medium; reading out a corresponding call process information from the first memory according to the requested call process function, reading out permit information from the second memory; and controlling about the execution of the call process function based on the call process information and the permit information.

According to yet another aspect of the present invention, there is provided a control method for use in a telephone exchange system comprising a telephone exchange apparatus to exchange a plurality of communication lines, and a telephone terminal connected to a terminal end of each of the communication lines, the method comprising: storing first type information showing a type of an own terminal in an information write disable first memory at the telephone terminal; storing second type information of a telephone terminal to be connected in an information write disable second memory at the telephone exchange apparatus; acquiring the first type information from the telephone terminal, reading out the second type information from the second memory, in the telephone exchange apparatus, when the telephone terminal is connected to the communication line; and controlling about connection validation of the telephone terminal by comparing the first type information and the second type information, in the telephone exchange apparatus.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a block diagram showing a schematic configuration of a exchange system according to a first embodiment of the invention;

FIG. 2 is a diagram showing an example of call process information stored in a database shown in FIG. 1;

FIG. 3 is a diagram showing an example of system type information stored in an information write disable memory shown in FIG. 1;

FIG. 4 is a diagram showing an example of copy protect data stored in the information write disable memory shown in FIG. 1;

FIG. 5 is a diagram showing an example of system own identifier information stored in the information write disable memory shown in FIG. 1;

FIG. 6 is a flowchart showing control process of a CPU for limiting call process action in the first embodiment;

FIG. 7 is a block diagram showing a schematic configuration of a switching system according to a second embodiment of the invention;

FIG. 8 is a diagram showing an example of terminal type data stored in a memory in a terminal shown in FIG. 7;

FIG. 9 is a diagram showing an example of system type information stored in a memory in a main device shown in FIG. 7;

FIG. 10 is a block diagram showing an apparatus configuration when writing terminal type data in a memory of a key telephone terminal in the second embodiment;

FIG. 11 is a sequence diagram showing signal transmission/reception operation when writing terminal type data in the memory of the key telephone terminal in the second embodiment;

FIG. 12 is a sequence diagram showing signal transmission/reception procedure when the main device acquires terminal type data from the key telephone terminal in the second embodiment; and

FIG. 13 is a flowchart showing control process procedure of a CPU in the second embodiment.

### DETAILED DESCRIPTION OF THE INVENTION

Referring now to the drawings, embodiments of the invention will be specifically described below.

### First Embodiment

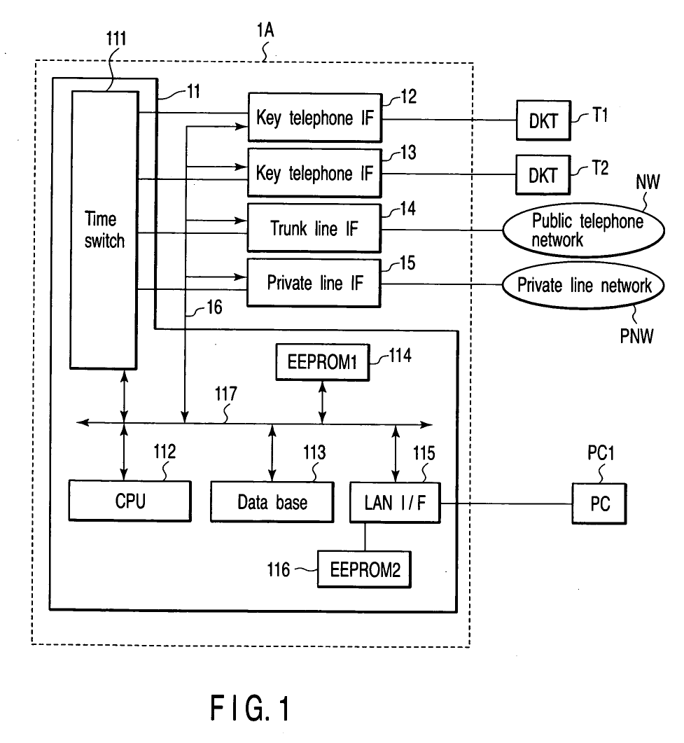

FIG. 1 is a diagram showing a schematic configuration of a switching system according to a first embodiment of the invention.

The switching system comprises, as shown in the diagram, a main apparatus 1A, and key telephone terminals T1, T2 which are arbitrarily connected thereto by way of individual extension interfaces.

The main apparatus 1A further includes a control unit 11, key telephone interface circuits 12, 13 (hereinafter referred to as key telephone IF 12, 13), an analog trunk line interface circuit 14 (hereinafter referred to as trunk line IF 14), a private line interface circuit 15 (referred to as private line IF 15). The control unit 11, key telephone IF 12, 13, trunk line IF 14, and private line IF 15 are mutually connected by way of a data highway 16.

The control unit 11 includes a time switch 111, a CPU 112, a database 113, an information write disable memory (EEPROM 1) 114, a LAN interface unit 115 (hereinafter referred to as LAN IF 115), and an information write disable memory (EEPROM 2) 116. The time switch 111, CPU 112, database 113, memory 114, and LAN IF 115 are mutually connected by way of a bus 117.

In the key telephone IF 12, the key telephone terminal T1 is connected as required. The key telephone IF 12 is responsible for key telephone IF operation about the connected key telephone terminal T1. The key telephone IF 12 also transmits/receives various items of control information about the extension interface operation to/from the control unit 11 by way of the data highway 16.

In the key telephone IF 13, the key telephone terminal T2 is connected as required. The key telephone IF 13 is responsible for key telephone IF operation about the connected key telephone terminal T2. The key telephone IF 13 also transmits/receives various items of control information about the extension interface operation to/from the control unit 11 by way of the data highway 16.

In the trunk line IF 14, an office line to be connected to a public telephone network NW is connected as required. The trunk line IF 14 is responsible for interface operation about the connected office line. The trunk line IF 14 also transmits/receives various items of control information about the interface operation to/from the control unit 11 by way of the data highway 16.

In the private line IF 15, a private line network PNW is connected as required. The private line IF 15 is responsible for interface operation about the connected private line. The private line IF 15 also transmits/receives various items of control information about the interface operation to/from the control unit 11 by way of the data highway 16.

The time switch 111 changes over the time slots on the PCM highway on the basis of the control by the CPU 112, and whereby arbitrarily switches and connects the key telephone IFs 12, 13, trunk line IF 14, and private line IF 15.

The CPU 112 executes processes according to the data stored in the database 113 and memories 114, 116, and thereby supervises and controls the time switch 111, key telephone IFs 12, 13, trunk line IF 14, and private line IF 15, and realizes the operation of the main apparatus 1A.

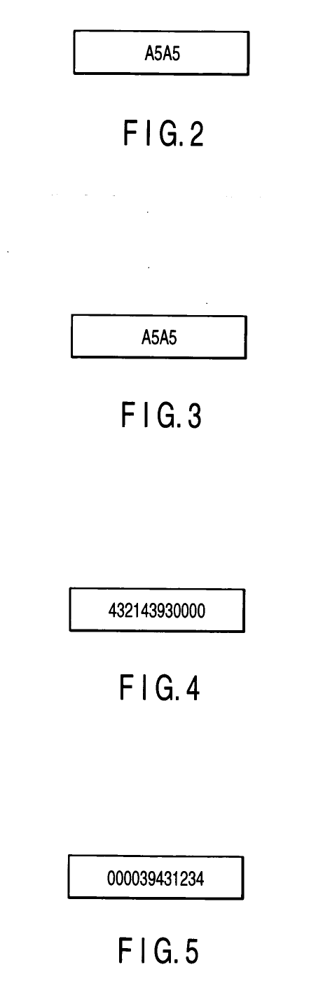

The database 113 stores call process information for executing call process operation of each nation. FIG. 2 shows an example of stored data, in which, for example, information for executing call process operation in Japan is stored.

The memory 114 stores system type information as permit information for executing preliminarily specified call process operation as shown in FIG. 3. The memory 114 also stores copy protect data as shown in FIG. 4.

The LAN IF 115 executes interface operation about the connected personal computer PC for maintenance. The memory 116 stores the system own identifier information intrinsic to the system written by a personal computer PC as shown in FIG. 5.

In this configuration, the operation will be described below.

First is explained the writing operating of system type information and copy protect data.

A manufacturer writes system type information (for example, local code) and copy protect data into the memory 114 by using the personal computer PC. The copy protect data is data obtained by, for example, ciphering system own identifier information (for example, media access control (MAC) address) by the manufacturer by using secret information. This secret information is stored in the memory 114, and preliminarily specified data code is used.

The system own identifier information is similarly written into the memory 116 from the personal computer PC. This data is data that cannot be changed by the maintenance engineer.

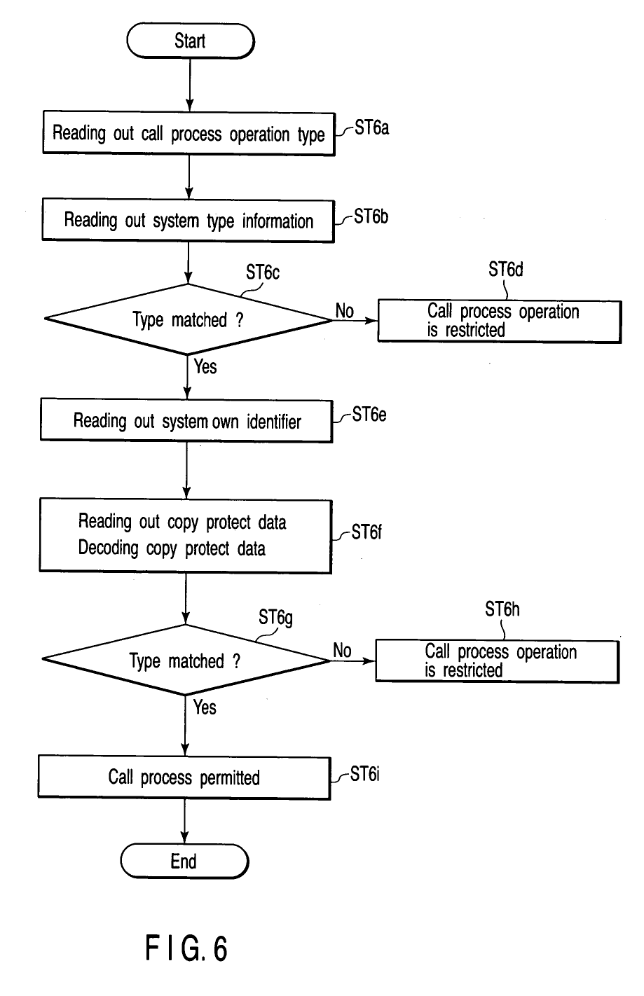

FIG. 6 is a flowchart showing control procedure of the CPU 112 for regulating the call process operation. First, when a user of the main apparatus 1A turns on a power source, the CPU 112 reads out the call process information from the database 113 (step ST6a), reads out the system type information from the memory 114 (step ST6b), and determines whether or not these information are matched (step ST6c). If not matched (No), the CPU 112 processes to define the call process operation are restricted (step ST6d).

When matched (Yes), on the other hand, the CPU 112 reads out the system own identifier information from the memory 114 (step ST6e), reads out the copy protect data from the memory 114 successively, and decodes this copy protect data by using the secret information stored in the memory 114 (step ST6f). The decoded data and the system own identifier information are compared with each other, and it is determined whether or not they coincide with each other (step ST6g). If not matched (No), the CPU 112 processes to define the call process operation are restricted (step ST6h).

On the other hand, when matched (Yes), the CPU 112 normally starts up the system, and executes the call process (step ST6i).

In the foregoing step ST6d and step ST6h, the system is started in the state of regulating the call process operation, but it is allowed to transfer to the maintenance mode from the key telephone terminals T1, T2, and outgoing and incoming call process operations are restricted.

Thus, in the first embodiment, in the CPU 112 of the main apparatus 1A, when the system is started, prior to execution of call process operation, it is determined whether or not the user who uses the key telephone terminals T1, T2 has the authorized right to use the main apparatus 1A by using the system type information stored in the information write disable memory 114, and the use of the key telephone terminals T1, T2 is permitted on the basis of this determination result.

Therefore, illegal use of the main apparatus 1A can be prevented, and the authorized user is immediately allowed to use the key telephone terminals T1, T2. At the same time, for the seller of the main apparatus 1A, loss by illegal use of the main apparatus 1A can be prevented. Further, since the system type information is stored in the information write disable memory 114, alteration or stealing of data by illegal user can be prevented.

In the first embodiment, the CPU 112 reads out the system own identifier information from the information write disable memory 116, reads out copy protect data from the memory 114, and compares these information. On the basis of the result of comparison, it is determined whether or not the call process request to be executed is requested by the authorized user.

Therefore, if the call process information or system type information is stolen by a third party, illegal use of the main apparatus 1A can be prevented, so that the security may be further enhanced.

Also in the first embodiment, as the copy protect data, the system own identifier information coded by secret information is used. Therefore, even if another user steals the copy protect data intentionally and attempts to execute the call process operation of the own main device, such illegal use is prevented.

### Second Embodiment

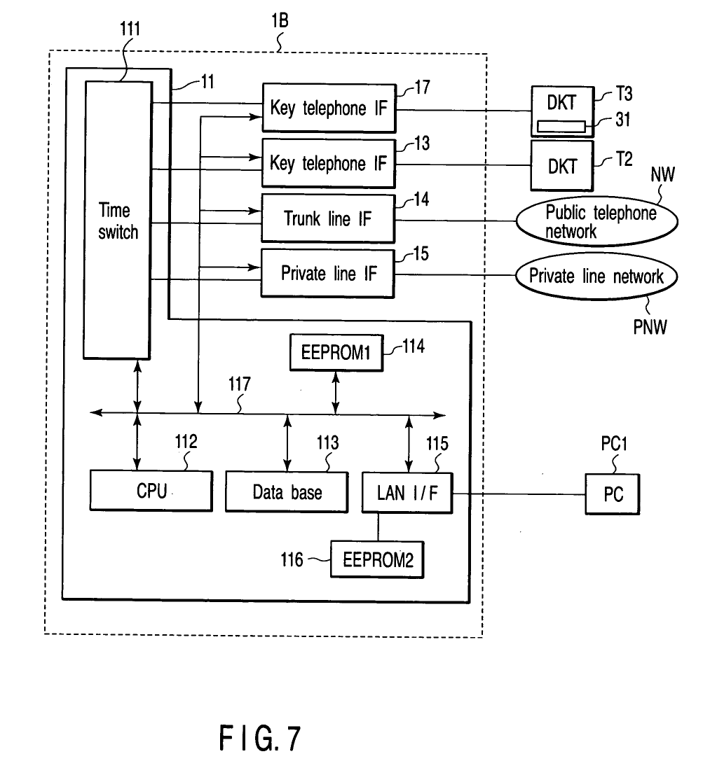

FIG. 7 is a diagram showing a schematic configuration of a switching system according to a second embodiment of the invention. In FIG. 7, same parts as in FIG. 1 are identified with same reference numerals.

A main apparatus 1B has an extension interface circuit 17 (hereinafter referred to as key telephone IF 17). The key telephone IF 17 has a new key telephone terminal T3.

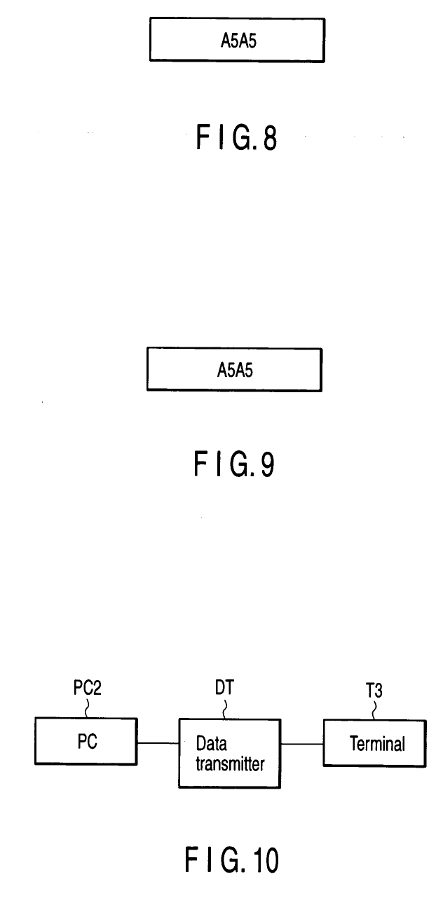

The key telephone terminal T3 has an information write disable memory 31. This memory 31 stores terminal type data showing a type of the key telephone terminal T3 as shown in FIG. 8.

On the other hand, a memory 114 of the main apparatus 1B stores system type information showing a terminal permitted to be connected as shown in FIG. 9.

In this configuration, the operation will be described below.

First is explained the writing operation of terminal type information into the memory 31 of the key telephone terminal T3.

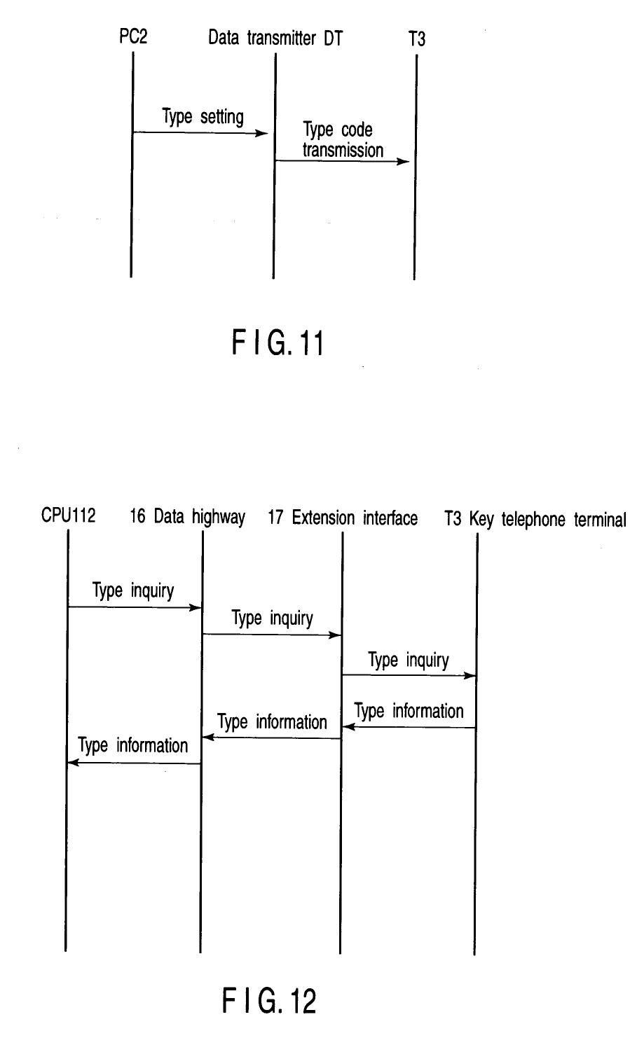

Herein, when writing the terminal type data into the memory 31 of the key telephone terminal T3, as shown in FIG. 10, a personal computer PC2 and a data transmitter DT are used. Suppose a manufacturer inputs the terminal type data by using the personal computer PC2. As a result, as shown in FIG. 11, the terminal type data is supplied into the data transmitter DT, and coded. The terminal type data coded by the data transmitter DT is sent into the key telephone terminal T3, and is written into the memory 31.

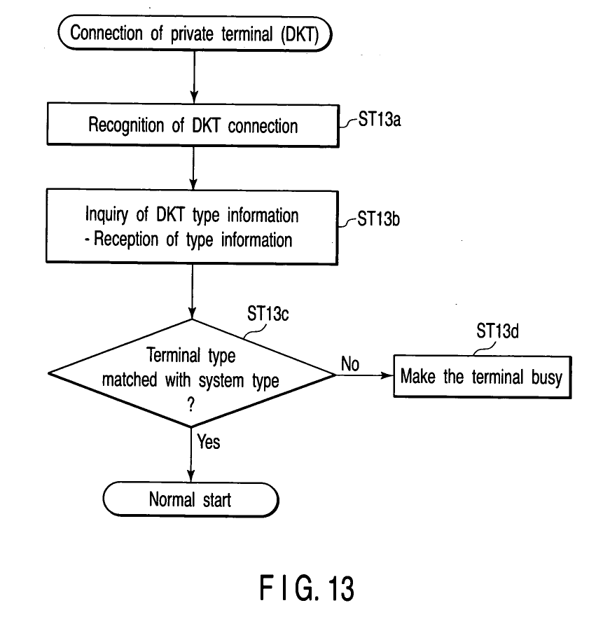

Next, when the key telephone terminal T3 is connected, the main apparatus 1B executes the following process. FIG. 12 is a sequence diagram showing the signal transmission/reception procedure when the main apparatus 1B acquires the terminal type data from the key telephone terminal T3, and FIG. 13 is a flowchart showing the control process procedure of the CPU 112.

When the key telephone terminal T3 is connected, the CPU 112 recognizes connection of the key telephone terminal T3 (step ST13a), and inquires the key telephone terminal T3 about the terminal type data (step ST13b). In response to the inquiry, when the terminal type data is received from the key telephone terminal T3, the CPU 112 reads out the terminal type data from the memory 114, and determines whether or not this terminal type data and the received terminal type data are matched (step ST13c). If not matched (No), the CPU 112 makes the key telephone terminal T3 to busy, and notices the key telephone terminal T3 of the prohibition of use (step ST13d).

When matched (Yes), on the other hand, the CPU 112 allows connection of the key telephone terminal T3.

Thus, in the second embodiment, when the key telephone terminal T3 is connected to the main apparatus 1B, in the main apparatus 1B, the terminal type data is acquired from the key telephone terminal T3, and this terminal type data and the terminal type data stored in the memory 114 are compared with each other. On the basis of the result of this comparison, it is determined whether or not the key telephone terminal T3 to be connected belongs to the authorized user.

Therefore, appropriate connection can be validated in every key telephone terminal T3 to be connected, and connection of an illegal terminal can be prevented, so that the security may be further enhanced.

Also in the second embodiment, if the connection of the key telephone terminal T3 is not validated, it is noticed to the key telephone terminal T3, and hence the user of the key telephone terminal T3 recognizes whether or not the connection is validated. At this time, in addition to the determining result of connection validation, if the reason or corresponding guidance information is noticed to the user, the user, if not accepted, knows the reason and can try again properly.

### Other Embodiments

The invention is not limited to these embodiments alone. For example, in these embodiments, the local nation code is used in the system type information and terminal type data. Not limited to this example, the code about the call process function allowed to be used may be used. Aside from the call process function, the number of connection terminals or the number of circuits to be used may be used as the regulating code.

In the first embodiment, the call process of the main apparatus is defined at the time of starting the system. Not limited to this example, call process may be defined in every demanded call process function. In this case, the system type information of every call process function permitted to be used may be stored in the memory 114.

Also in the first embodiment, the nation code showing the nation to be used is stored in the data base 113, but not limited to this example, the specifying code about all call process functions usable in the main apparatus 1A may be stored.

Besides, the invention may be applied by changing or modifying within a range not departing from the true spirit thereof, in the configuration or type of the system, configuration or type of the telephone exchange apparatus such as the main apparatus, type of the telephone terminal such as the key telephone terminal, control procedure for preventing illegal use, and type of information for preventing illegal use.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. A telephone exchange apparatus adapted to connect at least one telephone terminal via a communication network, the apparatus comprising:
a first storage unit to store a plurality of call process information for executing mutually different call process functions to the telephone terminal, in a first memory;
a second storage unit to store permit information for executing a specified call process function out of the plurality of call process functions, the permit information being preliminarily stored in each device, in an information write disable second memory;
a reader which reads out corresponding call process information from the first memory according to the requested call process function, reads out permit information from the second memory; and
a controller which controls about the execution of the call process function on based on these information.

2. The telephone exchange apparatus according to claim 1, further comprising:
a third storage unit to store own identifier information intrinsic to the device in the second memory; and
a fourth storage unit to store copy protect information for preventing copy of the own identifier information in the second memory,
wherein the reader reads out the own identifier information and the copy protect information from the second memory, when permitted to execute a call process function requested based on the call process information and permit information and
the controller controls about execution of the call process function based on the call process information and permit information.

3. The telephone exchange apparatus according to claim 2, wherein the fourth storage unit stores ciphered information as the copy protect information in the second memory, the ciphered information ciphering the own identifier information using secret information,
the reader reads out the own identifier information and the ciphered information from the second memory, and
the controller decodes the ciphered information by using the secret information, and authorizes execution of a call process function requested when the decoded information coincides with the own identifier information.

4. The telephone exchange apparatus according to claim 1, wherein the second storage unit stores specified information as the permit information in the second memory, the specified information specifying at least one of the number of connection terminals, the number of circuits to be used, operation permit or not about each call process function, and the nation to be used.

5. A telephone exchange system comprising a telephone exchange apparatus to exchange a plurality of communication lines, and a telephone terminal connected to a terminal end of each of the communication lines,
wherein the telephone terminal comprises:
a first storage unit to store first type information showing a type of an own terminal in an information write disable first memory,
the telephone exchange apparatus comprises:
a second storage unit to store second type information showing a type of a telephone terminal to be connected in an information write disable second memory;
a reader which acquires the first type information from the telephone terminal, reads out the second type information from the second memory, when the telephone terminal is connected to the communication line; and
a controller which controls about connection validation of the telephone terminal by comparing the first type information and the second type information.

6. The telephone exchange system according to claim 5, wherein the controller notices the telephone terminal at the destination of connection of the result of determination of connection permission of the telephone terminal.

7. A method of controlling a telephone exchange apparatus adapted to connect at least one telephone terminal via a communication line, the method comprising:
storing a plurality of call process information for executing mutually different call process functions to the telephone terminal in a first memory;
storing permit information for executing a specified call process function out of the plurality of call process functions, the permit information being preliminarily stored in each device, in an information write disable second recording medium;
reading out a corresponding call process information from the first memory according to the requested call process function, reading out permit information from the second memory; and
controlling about the execution of the call process function based on the call process information and the permit information.

8. The method according to claim 7, further comprising:
storing own identifier information intrinsic to the device in the second memory; and
storing copy protect information for preventing copy of the own identifier information in the second memory,
wherein the controlling includes reading out the own identifier information and the copy protect information from the second memory, and controlling about execution of the call process function based on the call process information and permit information, when permitted to execute a call process function requested based on the call process information and permit information.

9. The method according to claim 8, wherein the storing includes storing ciphered information as the copy protect information in the second memory, the ciphered information ciphering the own identifier information using secret information, and
the controlling includes reading out the own identifier information and the ciphered information from the second memory, decoding the ciphered information by using the secret information, and authorizing execution of a call process function requested when the decoded information coincides with the own identifier information.

10. The method according to claim 7, wherein the storing includes storing specified information as the permit information in the second memory, the specified information specifying at least one of the number of connection terminals, the number of circuits to be used, operation permit or not about each call process function, and the nation to be used.

11. A control method for use in a telephone exchange system comprising a telephone exchange apparatus to exchange a plurality of communication lines, and a telephone terminal connected to a terminal end of each of the communication lines, the method comprising:
storing first type information showing a type of an own terminal in an information write disable first memory at the telephone terminal;
storing second type information of a telephone terminal to be connected in an information write disable second memory at the telephone exchange apparatus;
acquiring the first type information from the telephone terminal, reading out the second type information from the second memory, in the telephone exchange apparatus, when the telephone terminal is connected to the communication line; and
controlling about connection validation of the telephone terminal by comparing the first type information and the second type information, in the telephone exchange apparatus.

12. The method according to claim 11, wherein the controlling includes noticing the telephone terminal at the destination of connection of the result of determination of connection permission of the telephone terminal.
